(19) United States
(12) Patent Application Publication
(10) Pub. No.: US 2012/0091039 A1
(43) Pub. Date: Apr. 19, 2012

(54) EBULLATED BED HYDROTREATING SYSTEMS AND PROCESSES OF HEAVY CRUDE OIL

(76) Inventors: Xiangchen Fang, Liaoning Province (CN); Suhua Sun, Liaoning Province (CN); Huihong Zhu, Liaoning Province (CN); Gang Wang, Liaoning Province (CN); Jie Liu, Liaoning Province (CN); Guang Yang, Liaoning Province (CN); Shenghua Yuan, Liaoning Province (CN); Li Cai, Liaoning Province (CN)

(21) Appl. No.: 13/272,993

(22) Filed: Oct. 13, 2011

(30) Foreign Application Priority Data
Oct. 13, 2010 (CN) 201010509320.1
Nov. 4, 2010 (CN) 201010536230.1
Nov. 4, 2010 (CN) 201010536246.2

(51) Int. Cl. C10G 45/08; B01J 23/54; B01J 23/85; B01J 8/02; B01J 8/04

(52) U.S. Cl. 208/216 PP; 422/211; 422/634; 502/313

(57) ABSTRACT

Disclosed are a mixed catalyst comprising catalyst A and catalyst B mixed in a volume ratio ranging from 1:0.1 to 1:10, heavy crude oil ebullated-bed hydrotreating systems comprising at least one ebullated-bed reactor comprising the mixed catalyst, and heavy crude oil ebullated-bed hydrotreating processes comprising: introducing heavy crude oil and hydrogen into at least one ebullated-bed reactor, reacting the heavy crude oil and the hydrogen with the mixed catalyst in the at least one ebullated-bed reactor to produce reaction products; and discharging the reaction products from the top of the at least one ebullated-bed reactor.

This application claims priority under 35 U.S.C. §119 to Chinese Patent Application No. 201010509320.1, filed Oct. 13, 2010, Chinese Patent Application No. 201010536230.1, filed Nov. 4, 2010, and Chinese Patent Application No. 201010536246.2, filed Nov. 4, 2010.

The present disclosure relates to a process and/or a system for hydrotreating heavy crude oil, such as poor-quality residua with a high content of heavy metal, using at least one ebullated-bed reactor.

In response to the gradual depletion of petroleum resources, the ever increasing demand for light oil, and the tighten rules and regulations for environmental protection, oil refining industry is constantly looking for ways to further improve the existing hydrotreating techniques, which include the use of fixed-bed, moving-bed, and ebullated-bed hydrogenation systems and/or processes.

Because the catalyst could be added and withdrawn online, ebullated-bed hydrogenation systems and/or processes have the advantages of maintaining a high and constant catalytic activity; long-cycle running time; and strong adaptability for feedstock (i.e., can be adapted to process the poor-quality feedstock such as vacuum residua with high contents of metal impurities).

The catalyst used in the ebullated-bed reactor is required not only to have the high hydrogenation and conversion activity, but also to have the high crushing strength and abrasion resistance for at least the following two reasons. First, in a hydrotreating system or process using an ebullated-bed reactor, the crude oil and hydrogen flow upstream through the catalyst bed; thus, the catalyst particles inside the reactor is in a state of irregular motion, i.e., a “boiling” state. Second, since the catalyst is added and withdrawn from the reactor periodically under high temperature and high pressure, the catalyst is in a turbulence state all the time in the reactor. As a result, there would be more chances for crash and friction, and breaking and abrasion are likely to happen, which would increase the consumption of catalyst or bring unfavorable effects to the downstream equipment.

In addition, since the catalyst is in a fluidized state in the reactor, there are additional requirements with respect to the bulk density, granular shape, and particle size distribution of catalyst. For example, the catalyst may, for example, be preferably in a spherical shape with a small particle size. Spherical particles can flow easily and do not have sharp and crude angles that can be easily crashed. Moreover, small and spherical particles may be relatively easy to maintain in a fluidized state in the reactor, which means that the desired flow rate can be smaller, and the hot oil recycle of high temperature and high pressure could be omitted, thereby reducing the power cost.

Hydrotreating systems or processes using an ebullated-bed reactor generally have a low operation space velocity but a high feedstock flow rate to keep the catalyst in a fluidized state. The ebullated-bed residua hydrocracking technique developed by Hydrocarbon Research Institute can increase the flow rate in the reactor by recycling the liquid-phase feedstock. Such technique, however, would change the system state in the reactor.

Two important reactions in the hydrogenation system or process of a heavy crude oil such as residua are hydrodesulfurization and hydrodemetallization. In a residua processing, it is rather challenging to covert asphaltene, which has a very complicated structure comprising a polymerized arene, an alkane chain, a cycloalkane ring, and heteroatoms such as sulphur, nitrogen and metal. Asphalten also has a high molecular weight and an average molecule size of 6˜9 nm. 80% to 90% of metal in crude oil can be present within asphaltene. That is, those metal impurities are often “deeply hidden” in asphalten molecules and could be removed only under the strict operation conditions.

The decomposition rate of asphaltene in hydrogenation process is related to the pore size of the catalyst that is used. The pore size of the catalyst can be at least greater than 10 nm to make it possible for asphaltene to diffuse into the pore channels of catalyst. Catalysts having high pore volume may absorb more impurities and enhance diffusion performance. Therefore, for the treatment of macromolecular compounds, it is desirable to use catalysts having a certain amount of macropores to allow large bitumen molecules to get closer to the inner surface of the catalyst so as to achieve the maximum hydrodemetallization degree. On the other hand, catalysts having too many macropores may have lower surface area and reduced desulphurization activity.

Various ebullated-bed hydrogenation techniques have been disclosed (see e.g., Chinese Patent No. 02109674.0, U.S. Pat. Nos. 6,270,654; 4,576,710; 4,457,831; and 3,809,644). However, there exists a constant need to further improve the operation performance, hydrogenation activity, and operation adaptability of an ebullated-bed residua hydrotreating process.

Provided herein is an ebullated-bed hydrotreating process, comprising: introducing heavy crude oil and hydrogen into at least one ebullated-bed reactor from, for example, the bottom of the at least one ebullated-bed reactor,

reacting the heavy crude oil and the hydrogen with at least one mixed catalyst in the at least one ebullated-bed reactor to produce reaction products; and

discharging the reaction products from, for example, the top of the at least one ebullated-bed reactor;

wherein the at least one mixed catalyst comprises catalyst A and catalyst B mixed in a volume ratio ranging from 1:0.1 to 1:10, such as ranging from 1:0.5 to 1:5 (i.e., the mixed volume ratio of catalyst A to catalyst B ranges from 1:0.1 to 1:10, such as from 1:0.5 to 1:5); and further wherein:

the catalyst A comprises:

(1) a specific surface area ranging from 80 m²/g to 200 m²/g,

(2) an average pore diameter of more than 20 nm, such as from 22 nm to 40 nm, wherein the percentage of the pore volume of the pores having a pore diameter ranging from 30 nm to 300 nm ranges from 35% to 60% by volume relative to the total pore volume of the catalyst A (measured by mercury injection method known in the art),

(3) at least one metal oxide of group VIB (e.g., MoO₃) in an amount ranging from 1.0% to 10.0%, such as from 1.5% to 6.5%, by weight relative to the total weight of the catalyst A, and

(4) at least one metal oxide of group VIII (e.g., NiO or CoO) in an amount ranging from 0.1% to 8.0%, such as from 0.5% to 5.0%, by weight relative to the total weight of the catalyst A; and

the catalyst B comprises:

(1) a specific surface area ranging from 180 m²/g to 300 m²/g;

(2) an average pore diameter ranging from 9 nm to 15 nm, wherein the percentage of the pore volume of the pores having a pore diameter of ranging from 5 nm to 20 nm is at least 70% by volume relative of the total pore volume of the catalyst B,

(3) at least one metal oxide of group VIB (e.g., MoO₃) in an amount ranging from 3.0% to 20.0%, such as from 6.0% to 15.0%, further such as from 0.3% to 8.0%, even further such as 0.5% to 5.0%, by weight relative to the total weight of the catalyst B, and

(4) at least one metal oxide of group VIII (e.g., NiO or CoO) in an amount ranging from 0.3% to 8.0% by weight relative to the total weight of the catalyst B.

Also provided herein is a system for hydrotreating heavy crude oil, comprising at least one ebullated-bed reactor comprising the at least one mixed catalyst, wherein the at least one mixed catalyst comprises catalyst A and catalyst B mixed in a volume ratio ranging from 1:0.1 to 1:10, as set forth above.

In some embodiments, the catalyst B or A may further comprise at least one additive chosen, for example, from: B, Ca, F, Mg, P, Si, and Ti, in an amount ranging from 0.5% to 5.0% by weight relative to the total weight of the catalyst B.

In some embodiments, in the catalyst B, the percentage of the pore volume of the pores having a pore diameter of greater than 20 nm ranges from 10% to 28%, such as from 10% to 25%, by volume relative to the total pore volume of the catalyst B, and the pore volume of the pores having a pore diameter of greater than 20 nm is not less than 0.1 ml/g, for example, from 0.1 ml/g to 0.3 ml/g.

In some embodiments, by the weight percent of the oxide in the respective catalyst, the weight percent of the hydrogenation active metal (a metal oxide of group VIB and a metal oxide of group VIII) in the catalyst B is 1% to 18%, such as 3% to 15%, higher than that of the hydrogenation active metal in the catalyst A. As a non-limiting example, if the content of the hydrogenation active metal oxide in the catalyst A is 2% by weight relative to the total weight of the catalyst A, then the weight percent of the hydrogenation active metal oxide in the catalyst B may range from 3% to 20%, such as from 5% to 17%, by weight relative to the total weight of the catalyst B.

In some embodiments, both the catalyst A and the catalyst B particles are spherical and have a diameter ranging, for example, from 0.1 mm to 0.8 mm, such as from 0.1 mm to 0.6 mm.

In some embodiments, the catalyst A and the catalyst B particles have an abrasion index of less than or equal to 2.0 wt %, as measured by ASTM D5757-00 Standard Test Method for Determination of Attrition and Abrasion of Powdered Catalysts by Air Jets.

In some embodiments, the support of the catalyst A and the catalyst B is Al₂O₃.

In some embodiments, the heavy crude oil that is introduced into the at least one ebullated-bed reactor can be any heavy oil or residua feedstock. As a non-limiting example, the heavy crude oil is an heavy hydrocarbon feedstock with a distillation temperature of higher than 500° C. and comprises sulphur, nitrogen, asphaltene, and a large amount of metal compounds (e.g., V, Fe, Ni, Ca, and/or Na), and also has a metal content of greater than 150 μg/g.

The reaction condition in the at least one ebullated-bed reactor may depend on the properties of the feedstock and the requirement of the reaction conversion. In some embodiments, the reaction condition may comprise: a reaction temperature ranging from 350° C. to 500° C.; a reaction pressure ranging from 8 MPa to 25 MPa; a volume ratio of hydrogen to oil ranging from 100:1 to 1000:1; and a liquid hourly space velocity (LHSV) ranging from 0.3 h⁻¹ to 5.0 h⁻¹.

In some embodiments, the heavy crude oil ebullated-bed hydrotreating system or process may use the conventional ebullated-bed reactors described in, for example, Chinese Patent No. 02109404.7.

In some embodiments, depending on the processing capacity of the unit, the heavy crude oil ebullated-bed hydrotreating system or process may comprise one ebullated-bed hydrogenation reactor or more than one ebullated-bed hydrogenation reactors used in parallel and/or in series, further wherein at least one ebullated-bed hydrogenation reactor comprises the mixed catalyst.

In some embodiments, the heavy crude oil ebullated-bed hydrotreating system or process is set up in a multi-stage. For example, in one embodiment, the system or process comprises 3 ebullated bed reactors used in series: a first ebullated bed reactor (herein referred to as R101), a second ebullated bed reactor (herein referred to as R102), and a third ebullated bed reactor (herein referred to as R103). In yet one embodiment, R101 and R102 are of a switch operation manner. That is, the operation is performed in cycle in accordance with the following mode:
the feedstocks go through R101, R102, and R103 sequentially; and then (i) when R101 is switched off for replacing the catalyst, the feedstocks go through R102 and R103 sequentially; and after the catalyst in R101 is replaced, the feedstocks go through R101, R102, and R103 sequentially; and
(ii) when R102 is switched off for replacing the catalyst, the feedstocks go through R101 and R103 sequentially; and after the catalyst in R102 is replaced, the feedstocks go through R101, R102, and R103 sequentially.

In addition, at least one reactor of R101, R102, and R103 is loaded with the mixed catalyst comprising the catalyst A and the catalyst B.

In some embodiments, a catalyst on-line addition and withdrawal system for the ebullated-bed reactors R101, R102 and/or R103 may be omitted to save the equipment investment. The switching time of R101 or R102 may be determined according to the deactivation rate of the catalyst used therein. For example, R101 may be switched off for replacing its catalyst once every 3 to 9 months; R102 may be switched off for replacing its catalyst once every 5 to 18 months. The specific time may be determined based on the desired reaction requirements. Since the feedstocks have gone through R101 and R102 for the hydrogenation and impurity-removal reaction, R103 could be maintained for a longer cycle running time, such as around 3 years.

In some embodiments, the system or process disclosed herein may further comprise a high-pressure low-temperature reactor R104. The pressure grade of R104 is identical to or similar to that of the reaction system (to omit the pressure loss caused by flow of feedstocks). In one embodiment, the temperature in R104 ranges from 150° C. to 300° C. In yet one embodiment, the operation condition of R104 is adjusted before R101 or R102 is switch off for replacing the catalyst. For example, when R101 or R102 is switched off from the reaction system, the catalyst in R101 or R102 is rapidly withdrawn into R104 to reduce the time needed for replacing the catalyst in the reactor and to reduce the effects caused by switching off one of the reactors. For instance, with the use of R104, it is possible to reduce the time needed for replacing the catalyst in one of the reactors by more than 50%.

In some embodiments, the three ebullated-bed reactors have the identical volume. The operation conditions may be determined according to the properties of the feedstocks and the reaction effects to be achieved. In one embodiment, the reaction conditions comprise: a reaction pressure ranging from 8 MPa to 25 MPa; a volume ratio of hydrogen to oil ranging from 100:1 to 1000:1; a liquid hourly space velocity (LHSV) ranging from 0.1 h⁻¹ to 5.0 h⁻¹; R101 may have a reaction temperature ranging from 380° C. to 430° C.; R102 may have a reaction temperature ranging from 380° C. to 430° C.; and R103 may have a reaction temperature ranging from 380° C. to 440° C.

In some embodiments, when R101 or R102 is switched off from the reaction system for replacing the catalyst, the amount of feedstock that is introduced into the reactors may be reduced to reduce potential impacts on the reaction. For example, the amount of the feedstock may be reduced to an amount ranging from 50% to 80% by weight relative to the total weight of the amount of the feedstock when none of the R101 and R102 is switched off (i.e., under the normal operation). Also, when the R101 or R102 is switched off for replacing catalyst, the reaction temperature of remaining ebullated-bed reactor may, for example, be increased to achieve the normal reaction effects which means the effects achieved before the switch operation of R101 or R102.

In some embodiments, in reactor(s) that does (do) not have the mixed catalyst comprising the catalyst A and the catalyst B, the catalysts with the following properties may be used:

(A) when the catalyst used in R101 is not the mixed catalyst comprising the catalyst A and the catalyst B, the catalyst in R101 may have the following properties: a specific surface area ranging from 80 m²/g to 200 m²/g; an average pore diameter of equal to or greater than 20 nm, such as from 22 nm to 40 nm, the percentage of the pore volume of the pores having a pore diameter of greater than 20 nm being at least 40% by volume relative to the total pore volume of the catalyst; at least one metal oxide of group VIB (e.g., MoO₃) in an amount ranging from 1.0% to 10.0%, such as from 1.5% to 8.5%, by weight relative to the total weight of the catalyst; and at least one metal oxide of group VIII (e.g., NiO or CoO) in an amount ranging from 0.1% to 8.0%, such as from 0.5% to 5.0%, by weight relative to the total weight of the catalyst.

(B) The catalyst used in R102 may be identical to or different from that used in R101. In addition, when the catalyst used in R102 is not the mixed catalyst comprising the catalyst A and the catalyst B, the catalyst in R102 may have the following properties: a specific surface area ranging from 80 m²/g to 300 m²/g; an average pore diameter of equal to or greater than 12 nm, such as from 12 nm to 30 nm, the percentage of the pore volume of the pores having a pore diameter of greater than 20 nm being at least 20% by volume relative to the total pore volume of the catalyst; at least one metal oxide of group VIB (e.g., MoO₃) in an amount ranging from 1.0% to 15.0%, such as from 1.5% to 13%, by weight relative to the total weight of the catalyst; at least one metal oxide of group VIII (e.g., NiO or CoO) in an amount ranging from 0.1% to 8.0%, such as from 1.0% to 5.0%, by weight relative to the total weight of the catalyst, and optionally at least one additive chosen, for example, from B, Ca, F, Mg, P, Si and Ti, in an amount ranging from 0% to 5.0% by weight relative to the total weight of the catalyst.

(C) when the catalyst used in R103 is not the mixed catalyst comprising the catalyst A and the catalyst B, the catalyst in R103 may have the following properties: a specific surface area ranging from 180 m²/g to 300 m²/g; an average pore diameter of equal to or greater than 9 nm, such as from 9 nm to 15 nm, the percentage of the pore volume of the pores having a pore diameter of greater than 20 nm being at least 10% by volume relative to the total pore volume of the catalyst; at least one metal oxide of group VIB (e.g., MoO₃) in an amount ranging from 3.0% to 20.0%, such as from 6.0% to 18.0%, by weight relative to the total weight of the catalyst, at least one metal oxide of group VIII (e.g., NiO or CoO) in an amount ranging from 0.3% to 8.0%, such as from 0.5% to 5.0%, by weight relative to the total weight of the catalyst; and optionally at least one additive chosen, for example, from B, Ca, F, Mg, P, Si, and Ti, in an amount ranging from 0% to 5.0% by weight relative to the total weight of the catalyst.

In some embodiments, the catalyst particles used in all of the three ebullated-bed reactors are spherical and have a diameter ranging from 0.1 mm to 0.8 mm, such as from 0.1 mm to 0.6 mm.

In some embodiments, the system or process further comprises a fixed bed reactor in combination with the at least one ebullated-bed reactor. In one embodiment, after going through the hydrogenation reaction in the at least one ebullated-bed reactor, the reaction products are discharged from the top of the at least one ebullated bed reactor and then introduced into the fixed bed reactor so as to carry out a further hydrogenation reaction under the hydrogenation conditions of the fixed bed. The reaction products of the fixed-bed reactor are then discharged from the bottom of the fixed-bed reactor and later enter into a separation system.

The fixed-bed hydrotreating reactor may contain at least one commercially available fixed-bed hydrotreating catalyst, chosen, for example, from FZC-20, FZC-30, and FZC-40 manufactured by Fushun Research Institute of Petroleum and Petrochemicals. The fixed bed hydrotreating catalyst may also be produced by the methods known in the art.

In some embodiments, the reaction conditions in the fixed-bed hydrotreating reactor may comprise: a reaction temperature ranging from 350° C. to 420° C.; a reaction pressure ranging from 8 MPa to 25 MPa; a volume ratio of hydrogen to oil ranging from 100:1 to 1000:1; a liquid hourly space velocity (LHSV) ranging from 0.3 h¹ to 2.0 h⁻¹.

In some embodiments, the mixed catalyst comprising both the catalyst A and the catalyst B with different physical-chemical properties can overcome certain deficiencies in systems or processes using either the catalyst A or the catalyst B alone. Because of certain limits in catalyst preparation techniques, it may be impossible to obtain different pore distributions and different active metal distributions within the same type of the catalyst. The ebullated-bed hydrotreating reaction system disclosed herein comprises mixing the catalysts with different properties to form a macroscopic catalyst having different pore distributions and different active metal distributions, thereby improving the reaction effects of the ebullated-bed hydrotreating reaction system.

Meanwhile, since the ebullated bed has a feature of being capable of adding and withdrawing catalysts on line to keep the constant hydrogenation activity, the proportions of the two catalysts could be adjusted in response to different reaction needs and to adapt to the changes of the catalyst activity and processing feedstock; thus, the operation flexibility may be further improved. Hydrogenation active metals of the catalyst A and the catalyst B are used in mixture, which may enhance the overall reaction performance of the reaction system and endow a higher hydrodesulphurization activity and demetallization activity as well as the appropriate asphaltene conversion performance, and possibly produce synergistic effects. Long-term experiments show that the supplemental amount of the fresh catalyst in the ebullated-bed system or process may be reduced by more than 10% using the system or process disclosed herein. In one embodiment, the catalyst A has a large pore size and a high metal deposit, and can lengthen the running life of the catalyst.

In the at least one ebullated-bed reactor, the catalyst A and catalyst B are in a completely mixed state, and the reaction feedstocks do not go through firstly the catalyst A and then the catalyst B. The catalyst B is still likely to contact the metal-containing macromolecules. Accordingly, the catalyst B should have a suitable structure and a suitable amount of macropores to ensure the suitable metal impurities deposit of the catalyst B in the ebullated-bed reaction system.

Besides, in some embodiments, the present disclosure uses a multi-stage ebullated bed residua hydrotreating system or process without the inclusion of a catalyst addition and withdrawal system, which thus largely reduces the equipment investment and the possibility of accidents; the long-cycle stable operation of the ebullated bed without the use of a catalyst on-line addition and withdrawal system is realized by the manners such as conducting the appropriate switching tests, using a backup reactor, and/or adjusting operation conditions.

### BRIEF DESCRIPTION OF THE DRAWINGS

FIG. 1 is a flow diagram of the multi-stage ebullated-bed heavy-oil hydrotreating process or system in accordance with the present disclosure, wherein 1 denotes valve 1, 2 denotes valve 2, 3 denotes valve 3, 4 denotes valve 4, 5 denotes valve 5, 6 denotes valve 6, 7 denotes valve 7, 8 denotes valve 8, 9 denotes valve 9, 10 denotes valve 10, 11 denotes valve 11, and 12 denotes valve 12.

In some embodiments, the ebullated bed reaction unit is set up with 3 reactors. The first reactor and second reactor can be switched off and the third reactor is not switched so as to replace the catalysts and attain a long-cycle operation. The technical devices can have an operation cycle of 3 years and be in synchronization with the catalytic cracking device as to start and stop. The ebullated-bed residue hydrogenation reactors are not set up with a catalyst on-line addition and withdrawal system to save on investment.

In some embodiments, the ebullated bed hydrogenation is set up with three reactors (R101, R102, and R103) in series, while a high-pressure low-temperature reactor (R104) with the same volume is set up for the switch operation of the reactors. No catalyst on-line addition and withdrawal system is set up to save on investment. When the catalyst of R101 is in the late period of operation, R101 is switched off. The feedstock of reaction goes through the other two reactors in sequence. After the catalyst is withdrawn from the switched-off reactor R101, the new catalyst is loaded. After reactor R101 is incorporated again into the system, it operates for a period of time before the second reactor R102 is switched off, and the reaction feedstock goes through R101 and R103 in sequence. After the catalyst is withdrawn from the switched-off reactor R102, the fresh catalyst is loaded. Then reactor R102 is incorporated again into the system, and the reaction feedstock goes through R101, R102, and R103 in sequence.

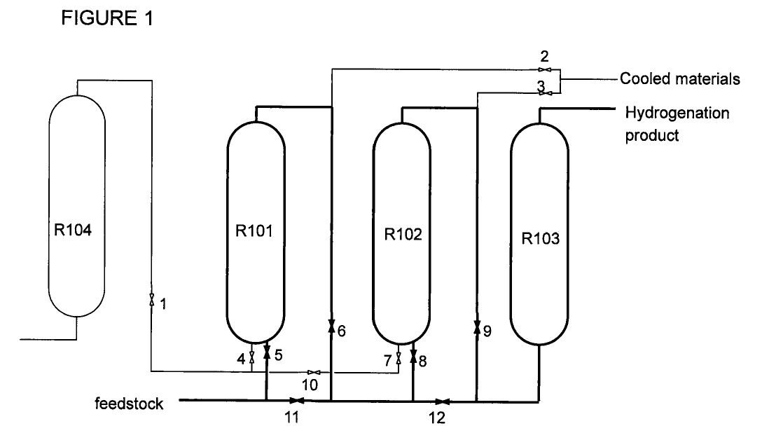

One of the embodiments is as shown in FIG. 1:

(1) when R101, R102 and R103 are in complete use, valve 5, valve 6, valve 8 and valve 9 are opened; valve 11 and valve 12 are closed; valve 1, valve 2, valve 3, valve 4, valve 7, and valve 10 are closed;

(2) when reactor R101 is switched off, valve 11, valve 8 and valve 9 are opened; valve 5, valve 6 and valve 12 are closed; at this time, reactor R101 is cleaned, and valve 1, valve 2 and valve 4 are opened for performing a cooling cycle, the catalyst is discharged, and valve 3, valve 10, and valve 7 are closed;

(3) when reactor R102 is switched off, valve 5, valve 6, and valve 12 are opened; valve 8, valve 9, and valve 11 are closed; at this time, reactor R102 is cleaned, and valve 1, valve 10, valve 7, and valve 3 are opened for performing a cooling cycle; the catalyst is discharged, and valve 4 and valve 2 are closed.

In the ebullated bed hydrotreating system or process disclosed herein, the catalyst A and the catalyst B can be prepared by the methods known in the art based on the performance requirements, for example, prepared with using the known techniques disclosed, for example, in U.S. Pat. No. 7,074,740, U.S. Pat. No. 5,047,142; U.S. Pat. No. 4,549,957, U.S. Pat. No. 4,328,127, and Chinese Patent No. 200710010377.5.

The preparation process of the ebullated bed hydrotreating catalyst comprises firstly preparing a microspheroidal catalyst support and then loading the desired hydrogenation active metal components by an impregnation method. In one embodiment, the preparation process of the catalyst support is set forth as follows: the raw material of a catalyst support with a suitable humidity is produced into the particles with the suitable size, and then the particles are subjected to spheroidization treatment, and then the spherical particle is dried and calcined to form a spherical catalyst support.

The drying and calcination of the catalyst support can be in the conditions known in the art. For example, the drying may be natural drying or drying at a temperature ranging, for example, from 80° C. to 150° C.; calcination can be performed at a temperature ranging, for example, from 600° C. to 1000° C. for a period of time ranging, for example, from 1 hour to 6 hours. The loading of the active hydrogenation metal components by an impregnation method can be performed by the methods known in the art. For example, the desired active metal salt may be formulated into a solution. Then, the solution containing the active metal salt may be used to impregnate the catalyst support. And then the final catalyst may be obtained by drying and calcination. The drying of the catalyst can be natural drying or drying at a temperature ranging, for example, from 60° C. to 150° C. The calcination process of the catalyst may be performed at a temperature ranging, for example, from 400° C. to 600° C. for a period of time ranging, for example, from 1 hour to 6 hours.

The raw materials of the microspheroidal support of the ebullated bed hydrotreating catalyst disclosed herein may be determined in light of application requirements. In one embodiment, for the heavy or residue hydrotreating catalyst support, the suitable raw materials may be chosen, for example, from the various precursors of alumina. Suitable additives may be added into the support raw materials to improve the various properties of the support. For example, the suitable additives can be chosen from carbon black, sesbania powder, starch, cellulose, and polyol. The hydrogenation active metal components such as one or more of tungsten, molybdenum, nickel, and cobalt, and additives may also be added as required. The common additives may be chosen, for example, from silicon, phosphorous, boron, fluorine, titanium, and zirconium. The addition amounts of the additives and metal components of the catalyst support may be determined in light of the application requirements of the catalyst. In some embodiments, the catalyst is sulphurized before it is applied to the heavy feedstock hydrogenation reaction to convert the active metal and metal additive into a sulphurized state. Sulphurization may be performed by use of the sulphurization methods known in the art.

The specific surface area of the catalyst is determined by using an N₂ adsorption method (the specific surface area of the solid substance is determined by a GB/T-19587-2004 gas adsorption BET method). The average pore size may be calculated from the specific surface area; and the pore volume may be determined by an N₂ adsorption method (average pore size (nm)=4000×pore volume/specific surface area). Both pore volume and pore size distribution are determined by using an N₂ adsorption method unless specifically indicated.

As used herein, the singular form “a”, “an” and “the” include plural references unless the context clearly dictates otherwise.

### EXAMPLES

The technical features and reaction effects of the present disclosure are further illustrated by the following examples, but are not limited to the examples. The percentage is weight percentage unless indicated otherwise.

### Example 1-1

1. Catalyst Preparation

A. Preparation of Catalyst A

A spherical catalyst support with an average pore size of 22 nm and a diameter of 0.4 mm was prepared. The other preparation steps were carried out with reference to U.S. Pat. No. 4,328,127 and Chinese Patent No. 200710010377.5.

A Mo—Ni solution was prepared by a conventional method. The solution had 4.01% of MoO₃ and 1.03% of NiO. This solution was used to impregnate the catalyst support set forth above in an equal volume ratio to obtain the final catalyst A, whose properties were shown in Table 1-1.

B. Preparation of Catalyst B

A spherical catalyst support with an average pore size of 11 nm and a diameter of 0.4 mm was prepared based on U.S. Pat. No. 7,074,740 and Chinese Patent No. 200710010377.5.

A Mo—Co—P solution was prepared by a conventional method. The solution had 11.20% of MoO₃, 2.59% of CoO, and 1.05% of P. This solution was used to impregnate the catalyst support in an equal volume ratio to obtain the final catalyst B, whose properties were shown in Table 1-1.

### Example 1-2

The catalyst A and the catalyst B as prepared in Example 1-1 were mixed in a volume ratio of 1:0.5 and introduced into a 1 L autoclave for conducting a vacuum residue hydrotreating test in the presence of hydrogen. The vacuum residue chosen for the test had the following properties: distillation temperature: 520° C. or over 520° C.; sulphur content: 2.8%; metal (Ni+V+Fe) content: 357 μg/g; asphaltene content: 6.8% (C₇ insoluble). Test conditions were: reaction temperature: 408° C.; reaction pressure: 15 MPa; reaction time: 0.5 h; oil/catalyst volume ratio: 15:1. The evaluation results were shown in Table 1-2.

### Example 1-3

The catalyst A and the catalyst B in Example 1-1 were mixed in a volume ratio of 1:5. The reaction pressure was 13 MPa. Other test conditions were the same as described in Example 1-2. The evaluation results were shown in Table 1-2.

### Example 1-4

The catalyst A and the catalyst Bin Example 1-1 were mixed in a volume ratio of 1:8. The reaction pressure was 15 MPa. The reaction time was 1 h. Other test conditions were the same as described in Example 1-2. The evaluation results were shown in Table 1-2.

### Example 1-5

The catalyst A and the catalyst B in Example 1-1 were mixed in a volume ratio of 1:2. The test conditions comprised: reaction temperature: 443° C.; reaction pressure: 15 MPa; the reaction time: 0.5 h. Other test conditions were the same as described in Example 1-2. The evaluation results were shown in Table 1-2.

### Example 1-6

The catalyst A and the catalyst B in Example 1-1 were mixed in a volume ratio of 1:2. The test conditions comprised: reaction temperature: 443° C.; reaction pressure: 11 MPa; the reaction time: 3 h. Other test conditions were the same as described in Example 1-2. The evaluation results were shown in Table 1-2.

### Example 1-7

A series of the catalysts A (wherein the average pore diameter and relevant parameters were varied, and all other aspects were the same) and the catalysts B (wherein the pore volume of the pores with a pore diameter of greater than 20 nm and relevant parameters were varied, and all other aspects were the same) were prepared in accordance with the methods of Example 1-1, and their properties are respectively shown in Tables 1-3 and 1-4. Moreover, the method of Example 1-6 was used to carry out a test. The evaluation results were shown in Table 1-5.

### Comparative Example 1-1

Only the catalyst B in Example 1-1 was used to perform the evaluation test. Other test conditions were to the same as those of Example 1-2. The evaluation results were shown in Table 1-2.

### Comparative Example 1-2

Only the catalyst A in Example 1-1 was used to perform the evaluation test. Other test conditions were to the same as those of Example 1-2. The evaluation results were shown in Table 1-2.

TABLE 1-1
Major Physical-Chemical Properties of The Catalyst A and The Catalyst B

| Items | Catalyst A | Catalyst B |
|---|---|---|
| MoO₃, wt % | 4.05 | 9.96 |
| NiO(CoO), wt % | 0.73 | 2.26 |
| P, wt % | — | 0.91 |
| Abrasion index, wt % | <2.0 | <2.0 |
| Particle diameter, mm | 0.4 | 0.4 |
| Total pore volume, | 1.49** | 0.67 |
| mL/g | | |
| Specific surface area, | 142 | 239 |
| m²/g | | |
| Average pore | 25 | 11 |
| diameter, nm | | |
| Pore size distribution* | Pores of <8 nm | Pores of 5-20 nm |
| | comprise 2%** | comprise 80% |
| | Pores of 30-300 nm | Pores of greater than |
| | comprise 50%** | 20 nm comprise |
| | | 18% and have a |
| | | pore volume of 0.12 mL/g |

*pore size distribution refers to the percentage of the pore volume of the pores with the diameters within the stated range relative to the total pore volume.
**measured by a mercury injection method.

TABLE 1-2
Evaluation Results of Catalyst Performances

| | Example | Example | Example | Example | Example | Comparative | Comparative |
|---|---|---|---|---|---|---|---|
| Items | 1-2 | 1-3 | 1-4 | 1-5 | 1-6 | Example 1-1 | Example 1-2 |
| Process conditions | 408 | 408 | 408 | 443 | 443 | 408 | 408 |
| Temperature/° C. | | | | | | | |
| Pressure/MPa | 15 | 13 | 15 | 15 | 11 | 15 | 15 |
| Reaction time/h | 0.5 | 0.5 | 1.0 | 0.5 | 3 | 0.5 | 0.5 |
| Oil/catalyst volume | 15:1 | 15:1 | 15:1 | 15:1 | 15:1 | 15:1 | 15:1 |
| ratio | | | | | | | |
| Relative | | | | | | | |
| hydrogenation | | | | | | | |
| activity | | | | | | | |
| Desulphurization | 95 | 104 | 115 | 121 | 145 | 100 | 85 |
| rate | | | | | | | |
| Demetallization | 137 | 104 | 108 | 142 | 140 | 100 | 138 |
| rate* | | | | | | | |
| Asphaltene | 116 | 103 | 110 | 124 | 132 | 100 | 118 |
| conversion | | | | | | | |

*the metal was (Ni + V + Fe).

In the above table, the activity of Comparative Example 1-1 was taken as 100, and the activity values of other examples were the relative activity obtained by being compared with Comparative Example 1-1.

It can be seen from the above table: when the hydrogenation catalysts A and B with different physical-chemical properties were mixed together and used as the mixed catalyst, the resulting hydrogenation activity was higher in one or more aspects represented by hydrodesulphurization rate, hydrodemallization rate, and asphaltene conversion as compared to using either catalyst A or catalyst B alone. The hydrodesulphurization rate, hydrodemallization rate, and asphaltene conversion are known in the art and can be measured and/or calculated by methods known in the art. For example, the hydrodesuiphurization rate=(the sulfur content in the feedstock−the sulfur content in the product)/(the sulfur content in the feedstock)×100.

TABLE 1-3

| | | | Catalyst | |
|---|---|---|---|---|
| | | | Ac (i.e., | |
| | | | the catalyst A | |
| | Catalyst | Catalyst | prepared in | Catalyst |
| Catalyst properties | Aa | Ab | Example 1-1) | Ad |
| Average pore diameter, nm | 16 | 22 | 25 | 34 |
| Specific surface area, m²/g | 201 | 161 | 142 | 90 |
| **Percentage of the pore | 18% | 38% | 50% | 55% |
| volume of the pores with | | | | |
| a pore diameter of 30-300 | | | | |
| nm relative to the total | | | | |
| pore volume | | | | |

**measured by a mercury injection method.

TABLE 1-4

| | | | Catalyst Bc | |
|---|---|---|---|---|
| | | | (i.e., the | |
| | | | catalyst B | |
| | Catalyst | Catalyst | prepared in | Catalyst |
| Catalyst properties | Ba | Bb | Example 1-1) | Bd |
| Average pore diameter, nm | 9 nm | 10 nm | 11 nm | 15 nm |
| Specific surface area, m²/g | 291 | 252 | 239 | 215 |
| Percentage of the pore | 73 | 78 | 80 | 72 |
| volume of the pores with | | | | |
| a pore diameter of 5-20 | | | | |
| nm relative to the total | | | | |
| pore volume, % | | | | |
| Percentage of the pores | 11 | 16 | 18 | 25 |
| with a pore diameter of | | | | |
| greater than 20 nm relative | | | | |
| to the total pore volume, % | | | | |
| Pore volume of the pores | 0.07 | 0.11 | 0.12 | 0.20 |
| with a pore diameter of | | | | |
| greater than 20 nm, ml/g | | | | |

TABLE 1-5
(process conditions and catalyst proportion were the same as those of Example 1-6)

| | | | | | Ac + Bc | | |
|---|---|---|---|---|---|---|---|
| Relative | | | | | (i.e., | | |
| hydrogenation | | | | | Example | | |
| activity | Aa + Ba | Aa + Bb | Ab + Ba | Ab + Bb | 1-6) | Ac + Bd | Ad + Bd |
| Desulphurization | 100 | 105 | 107 | 117 | 127 | 122 | 120 |
| rate | | | | | | | |
| Demetallization | 100 | 108 | 110 | 115 | 138 | 143 | 150 |
| rate* | | | | | | | |
| Asphaltene | 100 | 105 | 108 | 110 | 132 | 138 | 143 |
| conversion | | | | | | | |

*the metal was (Ni + V + Fe).

In the above table, the activity value obtained from the catalyst Aa+Ba was taken as 100, and the activity values obtained by other catalysts were the relative activity obtained by being compared with the catalyst Aa+Ba.

### Example 2

The example of the multi-stage ebullated-bed heavy oil hydrotreating process of the present invention is given as follows.

### Example 2-1

1. Catalyst Preparation

A spherical catalyst support with an average pore size of 24 nm and a diameter ranging from 0.1 mm to 0.3 mm was prepared. The Mo—Ni solution was prepared by a conventional method. The solution had a MoO₃ content of 6.00% and a NiO content of 1.80%. This solution was used to impregnate the above-mentioned support in an equal volume ratio to obtain the final catalyst 1-C whose properties were shown in Table 2-1.

A spherical catalyst support with an average pore size of 15 nm and a diameter ranging from 0.1 mm to 0.3 mm was prepared. The Mo—Ni—P solution was prepared by a conventional method. The solution had a MoO₃ content of 8.50%, a NiO content of 2.50%, and a P content of 1.00%. This solution was used to impregnate the above-mentioned support in an equal volume ratio to obtain the final catalyst 2-C whose properties were shown in Table 2-1.

TABLE 2-1
Major Physical-Chemical Properties of the Catalysts

| Properties | 1-C | 2-C |
|---|---|---|
| MoO₃, wt % | 6.82 | 8.36 |
| NiO(CoO), wt % | 1.69 | 2.18 |
| P, wt % | — | 1.05 |
| Abrasion index, wt % | <2.0 | <2.0 |
| Particle diameter, | 0.1-0.3 | 0.1-0.3 |
| mm | | |
| Pore volume, ml/g | 1.57* | 0.68 |
| Specific surface area, | 136 | 175 |
| m²/g | | |
| Percentage of the | 48.02 | 25.14 |
| pore volume of pores | | |
| having a pore size of | | |
| greater than 20 nm | | |
| relative to the total | | |
| pore volume, % | | |
| Average pore | 25 nm | 15 nm |
| diameter | | |

*measured by a mercury injection method

Therein, reactor R101 was loaded with Catalyst 1-C; reactor R102 was loaded with Catalyst 2-C; reactor R103 was loaded with a mixed catalyst of catalyst A and catalyst B in Table 1-1 with a volume ratio of 1:1.

### Example 2-2

The ebullated-bed hydrogenation reactor used in this example was a three-phase ebullated bed reactor (e.g., the ebullated bed reactors disclosed in Chinese Patent No. 02109404.7, Chinese Patent No. 200610134154.5 and Chinese Patent No. 200710012680.9 could be used) to satisfy the separation of the three phases of gas, liquid, and solid inside the ebullated-bed reactor.

The catalysts in Example 2-1 were used to be respectively fed into three 1 L three-phase ebullated bed reactors in series to perform a vacuum residue hydrotreating test in the presence of hydrogen. The vacuum residue chosen for the test had the following properties: distillation temperature: 520° C. or over 520° C.; sulphur (S) content: 2.60 wt. %; metal (Ni+V+Fe) content: 253 μg/g; CCR (Conradson carbon residue) content: 12.1%; asphaltene content: 5.9% (C₇ insoluble).

Test conditions and evaluation results were shown in Table 2-2.

TABLE 2-2
Process Conditions and Properties of the Product After Hydrogenation in
Example 2-2

| | Reactor | | |
|---|---|---|---|
| | R101 | R102 | R103 |
| Process conditions | | | |
| Reaction | 400 | 395 | 390 |
| temperature/° C. | | | |
| Reaction | 15 | | |
| pressure/MPa | | | |
| Space velocity/h⁻¹ | 1.0 | | |
| Hydrogen/oil | 900:1 | | |
| volume ratio | | | |
| Properties of the | | | |
| product oil | | | |
| S, wt % | 1.72 | 0.82 | 0.22 |
| (Ni + V + Fe), μg/g | 90.15 | 31.03 | 5.38 |
| CCR, % | 11.23 | 8.51 | 6.15 |
| Asphaltene (C₇ | 1.8 | 0.7 | <0.1 |
| insoluble), wt % | | | |

It can be seen from Table 2-2 that the product obtained from R103 can be used as the feedstock for a catalytic cracking process.

### Example 2-3

After catalyst 1-C in the ebullated-bed hydrogenation reactor R101 had be used for half a year, the properties of the product oil no longer satisfied the requirements (see Table 2-3). This indicated that the catalyst could not satisfy the requirements and needed to be changed.

Reactor R101 was switched off. Fresh feedstock and hydrogen were introduced into reactor R102 directly; at this moment, the fresh feedstock was 70% by weight relative to the original feedstock. The switched-off reactor R101 was maintained at the reaction pressure, into which recycled hydrogen and quenching oil were introduced to maintain the fluidization of the catalyst bed and avoid the unfluidized catalyst bed. When the temperature in reactor R101 was reduced to around 200° C., the catalyst of the reactor was withdrawn into the high-pressure low-temperature reactor R104 under pressure control; the catalyst in R104 was sufficiently washed, and then withdrawn to wait for the next operation. After the catalyst in reactor R101 was withdrawn into R104, a fresh catalyst was added in a low-pressure storage tank set up on the ground, and then the tank was switched to a hydrogen state; a fresh catalyst high-pressure tank was set up on top of the reactor, and the high-pressure tank was isolated from the reactor at first, and then the catalyst in the tank on the ground was transported to the high-pressure tank by hydrogen under low pressure; then the pressure of the high-pressure tank was raised above the reactor pressure, and the valve at the bottom was opened to add the catalyst into the reactor, and this operation was repeated till the catalyst in the ground catalyst tank was all added into the reactor.

Upon switching, the process conditions and product properties of R102 and R103 were shown in Table 2-3.

TABLE 2-3
Process Conditions and Product Properties Upon Switching in Example
2-3

| | Reactor | | |
|---|---|---|---|
| | R101 | R102 | R103 |
| Process conditions | Before | After switching | After switching |
| | switching | | |
| Reaction | 420 | 405 | 400 |
| temperature/° C. | | | |
| Reaction pressure/MPa | 15 | 15 | |
| Space velocity/h⁻¹ | 1.0 | 0.70 | |
| Hydrogen/oil volume | 900:1 | 900:1 | |
| ratio | | | |
| Properties of the | | | |
| product oil | | | |
| S, wt % | 2.31 | 0.98 | 0.27 |
| (Ni + V + Fe), μg/g | 215 | 46.78 | 7.98 |
| CCR, % | 11.92 | 9.12 | 6.94 |
| Asphaltene (C₇ | 5.0 | 0.8 | <0.1 |
| insoluble), % | | | |

It can be seen from Table 2-3: when the switching operation of R101 was carried out, the qualified catalytic cracking feestock can be obtained by reducing the flow rate of the feedstock entering reactor R102 and increasing the reaction temperatures of reactors R102 and R103.

### Example 2-4

Reactor R101 was incorporated again into the operation; before reactor 101 was incorporated again into the system, the pressure was adjusted to the normal pressure, and the temperature was around 200° C.; a 20% fresh feedstock was gradually introduced, while the reaction temperature was increased, and the fresh feedstock was gradually increased to 100%; with the increase of reaction temperature, the residue feedstock was gradually increased to 100%. At this moment, the process was performed following the multi-stage ebullated-bed heavy oil, residue hydrotreating process. After reactor R101 was switched off, the process conditions and product properties of the various reactors were shown in Table 2-4.

TABLE 2-4
Process Conditions and Product Properties Upon Switching in Example
2-4

| | Reactor | | |
|---|---|---|---|
| | R101 | R102 | R103 |
| Process conditions | After | After switching | After switching |
| | switching | | |
| Reaction | 400 | 400 | 393 |
| temperature/° C. | | | |
| Reaction pressure/ | 15 | | |
| Mpa | | | |
| Space velocity/h⁻¹ | 1.0 | | |
| Hydrogen/oil | 900:1 | | |
| volume ratio | | | |
| Properties of the | | | |
| generated oil | | | |
| S, % | 1.68 | 0.91 | 0.21 |
| (Ni + V + Fe), μg/g | 85.14 | 45.21 | 9.13 |
| CCR, % | 11.02 | 8.32 | 5.90 |
| Asphaltene (C₇ | 1.7 | 0.9 | <0.1 |
| insoluble), % | | | |

It can be seen from Table 2-4: after the catalyst in R101 was replaced and R101 was incorporated again into the system, the product obtained in R103 was the qualified catalytic cracking feedstock.

### Example 2-5

After the various reactors in Example 2-4 had been run for 1000 h, the process conditions and product properties of the various reactors were shown in Table 2-5.

TABLE 2-5
Process conditions and product properties after 1000 h of operation of
units

| | Reactor | | |
|---|---|---|---|
| | R101 | R102 | R103 |
| Process conditions | Operation for 1000 h | | |
| Reaction temperature/ | 403 | 410 | 395 |
| ° C. | | | |
| Reaction pressure/Mpa | 15 | | |
| Space velocity/h⁻¹ | 1.0 | | |
| Hydrogen/oil volume | 900:1 | | |
| ratio | | | |
| Properties of the | | | |
| generated oil | | | |
| S, % | 1.78 | 0.85 | 0.26 |
| (Ni + V + Fe), μg/g | 88.15 | 46.89 | 12.36 |
| CCR, % | 10.89 | 8.14 | 6.05 |
| Asphaltene (C₇ | 1.6 | 0.7 | <0.1 |
| insoluble), % | | | |

It can be seen from Table 2-5: after the various reactors had been operated normally for 1000 h, the stability was good, and the product quality did not change markedly, which was suitable for the catalytic cracking feedstock.

### Example 3

In this set of tests, the combination of ebullated bed and fixed bed was used. The catalyst A and the catalyst B were those in Table 1-1. The fixed bed catalysts were the commercially available catalysts FZC-30 and FZC-40 used for commercial units and manufactured by Fushun Research Institute of Petroleum and Petrochemicals. Their properties were shown in Table 3-1.

### Example 3-1

The catalyst A and the catalyst B in Example 1 were mixed in a volume ratio of 1:0.5 and introduced into a 1 L autoclave for performing a vacuum residue hydrotreating test in the presence of hydrogen. The vacuum residue for the test had the following properties: distillation range: 520° C. or over 520° C.; sulphur content: 2.8%; metal (Ni+V+Fe) content: 357 μg/g; asphaltene content: 6.8% (C₇ insoluble). Test conditions were: reaction temperature: 408° C.; reaction pressure: 13 MPa; reaction time: 0.5 h; oil/catalyst volume ratio: 15:1. The test was carried out for a few times by repeating the above-mentioned conditions, and then the catalyst was removed by filtration to obtain the product oil. The product oils obtained by the tests were mixed for the evaluation in the fixed bed.

FZC-30 and FZC-40 used for commercial units were graded and introduced into a 200 ml small fixed-bed hydrogenation device in a volume ratio of 3:1. After the conventional sulphurization treatment, the hydrotreating test was carried out in the presence of hydrogen. Test conditions were: reaction temperature: 395° C.; reaction pressure: 15 MPa; hydrogen/oil volume ratio: 900:1; liquid hourly space velocity: 0.5 h⁻¹. The evaluation results were shown in Table 3-2.

### Example 3-2

In Example 3-1, the catalyst A and the catalyst B in Example 1 were mixed in a volume ratio of 1:5. The fixed bed had a reaction temperature of 385° C. Other test conditions did not change. The evaluation results were shown in Table 3-2.

### Example 3-3

In Example 3-1, the catalyst A and the catalyst B in Example 1 were mixed in a volume ratio of 1:8. The fixed bed had a reaction pressure of 13 MPa and a hydrogen/oil volume ratio of 700:1. Other test conditions did not change. The evaluation results were shown in Table 3-2.

### Example 3-4

In Example 3-1, the catalyst A and the catalyst B in Example 1 were mixed in a volume ratio of 1:2. Test conditions of the ebullated bed were: reaction temperature: 443° C.; reaction pressure: 15 MPa; reaction time: 0.5 h; oil/catalyst volume ratio: 15:1; the hydrogen/oil volume ratio of the fixed bed was 700:1. Other test conditions did not change. The evaluation results were shown in Table 3-2.

### Example 3-5

In Example 3-1, the catalyst A and the catalyst B in Example 1 were mixed in a volume ratio of 1:2. Test conditions were: reaction temperature: 443° C.; reaction pressure: 11 MPa; reaction time: 3 h; oil/catalyst volume ratio: 15:1; the fixed bed had a reaction pressure of 13 MPa and a hydrogen/oil volume ratio of 700:1. Other test conditions did not change. The evaluation results were shown in Table 3-2.

### Comparative Example 3-1

Only the catalyst B in Example 1-1 was used to perform the evaluation test. Other test conditions were to the same as those of Example 3-1. The evaluation results were shown in Table 3-2.

### Comparative Example 3-2

Only the catalyst A in Example 1-1 was used to perform the evaluation test. Other test conditions were the same as those of Example 3-1. The evaluation results were shown in Table 3-2.

TABLE 3-1
Major Physical-Chemical Properties of the Catalysts

| Properties | FZC-30 | FZC-40 |
|---|---|---|
| MoO₃, wt % | 19.7 | 22.5 |
| NiO(CoO), wt % | 4.51 | 9.3 |
| P, wt % | 1.82 | — |
| Particle diameter, | 3.6 | 4 |
| mm | | |
| Pore volume, | 0.41 | 0.40 |
| mL/g | | |
| Specific surface | 148 | 195 |
| area, m²/g | | |
| Pore size | 6-10 nm | 4-15 nm |
| distribution* | 73% | 88% |

*pore size distribution refers to the percentage of the pore volume of the pores with the diameters within the stated range relative to the total pore volume.

TABLE 3-2
Evaluation Results of Catalyst Performances

| | | | | | | Comparative | Comparative |
|---|---|---|---|---|---|---|---|
| | Example | Example | Example | Example | Example | Example | Example |
| | 3-1 | 3-2 | 3-3 | 3-4 | 3-5 | 3-1 | 3-2 |
| Ebullated bed | | | | | | | |
| process conditions | | | | | | | |
| Temperature/° C. | 408 | 408 | 408 | 443 | 443 | 408 | 408 |
| Pressure/MPa | 13 | 13 | 13 | 15 | 11 | 13 | 13 |
| Reaction time/h | 0.5 | 0.5 | 0.5 | 0.5 | 3 | 0.5 | 0.5 |
| Oil/catalyst volume | 15:1 | 15:1 | 15:1 | 15:1 | 15:1 | 15:1 | 15:1 |
| ratio | | | | | | | |
| Fixed bed process | | | | | | | |
| conditions | | | | | | | |
| Temperature/° C. | 395 | 385 | 395 | 395 | 395 | 395 | 395 |
| Pressure/MPa | 15 | 15 | 13 | 15 | 13 | 15 | 15 |
| Hydrogen/oil | 900:1 | 900:1 | 700:1 | 700:1 | 700:1 | 900:1 | 900:1 |
| volume ratio | | | | | | | |
| Space velocity/h⁻¹ | 0.5 | 0.5 | 0.5 | 0.5 | 0.5 | 0.5 | 0.5 |
| Relative | | | | | | | |
| hydrogenation | | | | | | | |
| activity | | | | | | | |
| Desulphurization | 89 | 108 | 118 | 125 | 152 | 100 | 82 |
| rate | | | | | | | |
| Demetallization | 128 | 102 | 98 | 143 | 145 | 100 | 130 |
| rate* | | | | | | | |
| Asphaltene | 120 | 105 | 102 | 129 | 138 | 100 | 121 |
| conversion | | | | | | | |

*the metal was (Ni + V + Fe).

In the above table, the activity of Comparative Example 3-1 was taken as 100, and the activity values of other examples were the relative activity obtained by being compared with Comparative Example 3-1.

It can be seen from the above table: when the catalysts A and B with different physical-chemical properties were mixed together and used in the ebullated-bed reactor in combination with the fixed bed, the resulting hydrogenation activity was higher in one or more aspects represented by hydrodesulphurization rate, hydrodemallization rate, and asphaltene conversion as compared to a single catalyst used for the ebullated bed.

What is claimed is:

1. A heavy crude oil ebullated-bed hydrotreating process comprising:
introducing heavy crude oil and hydrogen into at least one ebullated-bed reactor;
reacting the heavy crude oil and the hydrogen with at least one mixed catalyst in the at least one ebullated-bed reactor to produce a reaction product; and
discharging the reaction product;
wherein the at least one mixed catalyst comprises catalyst A and catalyst B mixed in a volume ratio ranging from 1:0.1 to 1:10;
further wherein:
the catalyst A comprises:
(1) a specific surface area ranging from 80 m²/g to 200 m²/g,
(2) an average pore diameter of more than 20 nm, wherein percentage of the pore volume of the pores having a pore diameter of ranging from 30 nm to 300 nm ranges from 35% to 60% by volume relative to the total pore volume of the catalyst A,
(3) at least one metal oxide of group VIB in an amount ranging from 1.0% to 10.0% by weight relative to the total weight of the catalyst A, and
(4) at least one metal oxide of group VIII in an amount ranging from 0.1% to 8.0% by weight relative to the total weight of catalyst A; and
the catalyst B comprises:
(1) a specific surface area ranging from 180 m²/g to 300 m²/g,
(2) an average pore diameter ranging from 9 nm to 15 nm, wherein percentage of the pore volume of the pores having a pore diameter of ranging from 5 nm to 20 nm is at least 70% by volume relative to the total pore volume of the catalyst B;
(3) at least one metal oxide of group VIB in an amount ranging from 3.0% to 20.0% by weight relative to the total weight of the catalyst B, and
(4) at least one metal oxide of group VIII in an amount ranging from 0.3% to 8.0% by weight relative to the total weight of catalyst B.

2. A system for hydrotreating heavy crude oil, comprising at least one ebullated-bed reactor comprising at least one mixed catalyst, wherein the at least one mixed catalyst comprises catalyst A and catalyst B mixed in a volume ratio ranging from 1:0.1 to 1:10; wherein:
the catalyst A comprises:
(1) a specific surface area ranging from 80 m²/g to 200 m²/g,
(2) an average pore diameter of more than 20 nm, wherein percentage of the pore volume of the pores having a pore diameter of ranging from 30 nm to 300 nm ranges from 35% to 60% by volume relative to the total pore volume of the catalyst A,
(3) at least one metal oxide of group VIB in an amount ranging from 1.0% to 10.0% by weight relative to the total weight of the catalyst A, and
(4) at least one metal oxide of group VIII in an amount ranging from 0.1% to 8.0% by weight relative to the total weight of catalyst A; and
the catalyst B comprises:
(1) a specific surface area ranging from 180 m²/g to 300 m²/g,
(2) an average pore diameter ranging from 9 nm to 15 nm, wherein percentage of the pore volume of the pores having a pore diameter of ranging from 5 nm to 20 nm is at least 70% by volume relative to the total pore volume of the catalyst B;
(3) at least one metal oxide of group VIB in an amount ranging from 3.0% to 20.0% by weight relative to the total weight of the catalyst B, and
(4) at least one metal oxide of group VIII in an amount ranging from 0.3% to 8.0% by weight relative to the total weight of catalyst B.

3. The system according to claim 2, wherein both the catalyst A and the catalyst B particles are spherical and have a diameter ranging from 0.1 mm to 0.8 mm.

4. The system according to claim 2, wherein the average pore diameter of the catalyst A ranges from 22 nm to 40 nm.

5. The system according to claim 2, wherein the catalyst A and the catalyst B are mixed in a volume ratio ranging from 1:0.5 to 1:5.

6. The system according to claim 2, wherein the weight percent of the at least one metal oxide of group VIB and the at least one metal oxide of group VIII, in the catalyst B is 1% to 18% higher than that in the catalyst A.

7. The system according to claim 2, wherein in the catalyst B, the percentage of the pores having a pore diameter of greater than 20 nm is in an amount ranging from 10% to 28% by volume relative to the total volume of the catalyst B, and the pore volume of the pores having a pore diameter of greater than 20 nm is not less than 0.1 ml/g.

8. The system according to claim 2, wherein in the catalyst B, the percentage of the pores having a pore diameter of greater than 20 nm is in an amount ranging from 10% to 25% by volume relative to the total volume of the catalyst B, and the pore volume of the pores having a pore diameter of greater than 20 nm ranges from 0.1 ml/g to 0.3 ml/g.

9. The system according to claim 2, wherein:
in the catalyst A, the at least one metal oxide of group VIB is in an amount ranging from 1.5% to 6.5% by weight relative to the total weight of the catalyst A, and the at least one metal oxide of group VIII is in an amount ranging from 0.5% to 5.0% by weight relative to the total weight of the catalyst A; and/or
in the catalyst B, the at least one metal oxide of group VIB is in an amount ranging from 6.0% to 15.0% by weight relative to the total weight of the catalyst B, and the at least one metal oxide of group VIII is in an amount ranging from 0.5% to 5.0% by weight relative to the total weight of the catalyst B.

10. The system according to claim 2, wherein the ebullated-bed reactor has a reaction condition comprising: a reaction temperature ranging from 350° C. to 500° C.; a reaction pressure ranging from 8 MPa to 25 MPa; a volume ratio of hydrogen to oil ranging from 100:1 to 1000:1; and a liquid hourly space velocity ranging from 0.3 h⁻¹ to 5.0 h⁻¹.

11. The system according to claim 2, wherein multiple ebullated bed hydrogenation reactors are used in parallel and/or in series, wherein at least one ebullated bed hydrogenation reactor comprises said at least one mixed catalyst.

12. The system according to claim 2, comprising three ebullated-bed reactors in series: a first ebullated bed reactor R101, a second ebullated-bed reactor R102, and a third ebullated-bed reactor R103; wherein at least one reactor of R101, R102, and R103 comprises the at least one mixed catalyst, and further wherein reaction feedstock goes through R101, R102, and R103 sequentially; and
(i) when R101 is switched off for replacing catalyst, the reaction feedstock goes through R102 and R103 sequentially; and after the catalyst in R101 is replaced, the reaction feedstock goes through R101, R102, and R103 sequentially; and
(ii) when R102 is switched off for replacing catalyst, the reaction feedstock goes through R101 and R103 sequentially; and after the catalyst in R102 is replaced, the reaction feedstock goes through R101, R102, and R103 sequentially.

13. The system according to claim 12, wherein no catalyst on-line addition and withdrawal system is set up for the ebullated-bed reactors R101, R102, and/or R103.

14. The system according to claim 12, wherein the first ebullated-bed reactor R101 is switched off for replacing catalyst once every 3 to 9 months and the second ebullated-bed reactor R102 is switched off for replacing catalyst once every 5 to 18 months.

15. The system according to claim 12, further comprising a high-pressure low-temperature reactor R104, wherein the temperature of R104 ranges from 150° C. to 300° C., and when the R101 or R102 is switched off, the catalyst in the R101 or R102 is withdrawn into the R104.

16. The system according to claim 12, wherein the three ebullated-bed reactors have the same volume.

17. The system according to claim 12, wherein:
reaction pressure ranges from 8 MPa to 25 MPa; volume ratio of the hydrogen to oil ranges from 100:1 to 1000:1; total liquid hourly space velocity ranges from 0.1 h⁻¹ to 5.0 h⁻¹; and
the R101 has a reaction temperature ranging from 380° C. to 430° C., the R102 has a reaction temperature ranging from 380° C. to 430° C., and the R103 has a reaction temperature ranging from 380° C. to 440° C.

18. The system according to claim 12, wherein when the R101 or R102 is switched off for replacing catalyst, the amount of feedstock is reduced to an amount ranging from 50% to 80% by weight relative to the total weight of the amount of the feedstock when none of the R101 and R102 is switched off.

19. The system according to claim 12, wherein, when the R101 or R102 is switched off for replacing catalyst, the reaction temperature of remaining ebullated-bed reactor is increased to achieve normal reaction effects before the switch operation of R101 or R102.

20. The system according to claim 12, wherein the R101 comprises a catalyst having:
a specific surface area ranging from 80 m²/g to 200 m²/g;
an average pore diameter of greater than 20 nm, wherein the percentage of the pore volume of the pores having a pore diameter greater than 20 nm is in amount of at least 40% by volume relative to the total pore volume of the catalyst;
at least one metal oxide of group VIB in an amount ranging from 1.0% to 10.0% by weight relative to the total weight of the catalyst; and
at least one metal oxide of group VIII in an amount ranging from 0.1% to 8.0% by weight relative to the total weight of the catalyst.

21. The system according to claim 12, wherein the R102 comprises a catalyst having:
a specific surface area ranging from 80 m²/g to 300 m²/g;
an average pore diameter of greater than 12 nm, wherein the percentage of the pore volume of the pores having a pore diameter greater than 20 nm is in amount of at least 20% by volume relative to the total pore volume of the catalyst;
at least one metal oxide of group VIB in an amount ranging from 1.0% to 15.0% by weight relative to the total weight of the catalyst; and
at least one metal oxide of group VIII in an amount ranging from 0.1% to 8.0% by weight relative to the total weight of the catalyst.

22. The system according to claim 12, wherein the R103 comprises a catalyst having:
a specific surface area ranging from 180 m²/g to 300 m²/g;
an average pore diameter of greater than 9 nm, wherein the percentage of the pore volume of the pores having a pore diameter greater than 20 nm is in amount of at least 10% by volume relative to the total pore volume of the catalyst;
at least one metal oxide of group VIB in an amount ranging from 3.0% to 20.0% by weight relative to the total weight of the catalyst; and
at least one metal oxide of group VIII in an amount ranging from 0.3% to 8.0% by weight relative to the total weight of the catalyst.

23. The system according to claim 12, wherein catalyst particles in all of the three ebullated-bed reactors are spherical and have a diameter ranging from 0.1 mm to 0.8 mm.

24. The system according to claim 2, further comprising a fixed bed reactor in combination with the at least one ebullated bed reactor; and wherein the reaction product discharged from the top of the at least one ebullated-bed reactor is delivered to the fixed bed reactor for a further hydrogenation reaction.

25. The system according to claim 24, wherein the reaction product of the fixed bed reactor is discharged from the bottom of the fixed bed reactor and then delivered to a separation system.

26. The system according to claim 25, wherein the hydrogenation reaction in the fixed bed hydrotreating comprises a reaction temperature ranging from 350° C. to 420° C., a reaction pressure ranging from 8 MPa to 25 MPa, a volume ratio of hydrogen to oil ranging from 100:1 to 1000:1, and a liquid hourly space velocity ranging from 0.3 h⁻¹ to 2.0 h⁻¹.

27. A mixed catalyst for hydrotreating heavy crude oil comprising:
catalyst A and catalyst B mixed in a volume ratio ranging from 1:0.1 to 1:10; wherein:
the catalyst A comprises:
(1) a specific surface area ranging from 80 m²/g to 200 m²/g,
(2) an average pore diameter of more than 20 nm, wherein the percentage of the pore volume of the pores having a pore diameter of ranging from 30 nm to 300 nm ranges from 35% to 60% by volume relative to the total pore volume of the catalyst A,
(3) at least one metal oxide of group VIB in an amount ranging from 1.0% to 10.0% by weight relative to the total weight of the catalyst A, and
(4) at least one metal oxide of group VIII in an amount ranging from 0.1% to 8.0% by weight relative to the total weight of the catalyst A; and
the catalyst B comprises:
(1) a specific surface area ranging from 180 m²/g to 300 m²/g,
(2) an average pore diameter ranging from 9 nm to 15 nm, wherein the percentage of the pore volume of the pores having a pore diameter of ranging from 5 nm to 20 nm is at least 70% by volume of the total pore volume of the catalyst B;
(3) at least one metal oxide of group VIB in an amount ranging from 3.0% to 20.0% by weight relative to the total weight of the catalyst B, and
(4) at least one metal oxide of group VIII in an amount ranging from 0.3% to 8.0% by weight relative to the total weight of the catalyst B.
